(19) United States
(12) Patent Application Publication
(10) Pub. No.: US 2002/0112177 A1
(43) Pub. Date: Aug. 15, 2002

(54) Anonymous biometric authentication

(76) Inventors: William H. Voltmer, Princeton Junction, NJ (US); John E. Siedlarz, Indian Mills, NJ (US); James L. Cambier, Medford, NJ (US); Herbert Ronald Fineburg, Wallingford, PA (US)

Correspondence Address: Michael K. Jones, Woodcock Washburn Kurtz, Mackiewicz & Norris LLP, One Liberty Place - 46th Floor, Philadelphia, PA, 19103, US

(21) Appl. No.: 09/781,333

(22) Filed: Feb. 12, 2001

(51) Int. Cl. H04L 9/32

(52) U.S. Cl. 713/200

(57) ABSTRACT

The use of an anonymous biometric authentication system and method that use biometrics to anonymously authenticate an individual and grant certain privileges based on the anonymous authentication is provided. The system and method permit enrollment of an individual by submission of a first biometric and associated identity documents or credentials to an enrollment authority. The enrollment authority verifies the identity of the identity of the individual submitting the biometric using the credentials which are then returned to the individual or discarded. The first biometric is stored in a database for later retrieval in anonymously authenticating an individual seeking to exercise certain privileges. No other personal identity information is stored along with the biometric during the enrollment process. When an individual later seeks to exercise certain privileges, they must submit a second biometric that is compared to the stored biometrics in the database in order to anonymously authenticate the identity of the individual as having access to such privileges. No other personal information is captured, collected, or solicited during the authentication process. Privileges are granted to an individual based on the comparison of the later captured biometric to the stored biometrics in the database. Alternatively, the anonymous biometric authentication system can be designed to avoid repeat offenders by capturing a biometric of an individual seeking to exercise a privilege and denying the privilege if the captured biometric is matched to a biometric stored in a database containing the biometrics of previous offenders. Preferably, the system and method include capture and storage of a powerful biometric identifier based on the iris of the eye which uniquely identifies the individual that has submitted the biometric. Anonymous biometric authentication allows verification of the identity of an individual seeking certain privileges while at the same time protecting the privacy of personal information about the individual.

### FIELD OF THE INVENTION

The present invention relates in general to biometric authentication, and particularly, to a system that uses biometrics for anonymous authentication of an individual in order to determine whether to grant certain privileges to the individual submitting the biometric.

### BACKGROUND OF THE INVENTION

The need to establish personal identity occurs, for most individuals, many times a day. For example, a person may have to establish identity in order to gain access to, physical spaces, computers, bank accounts, personal records, restricted areas, reservations, and the like. Identity is typically established by something we have (e.g., a key, driver license, bank card, credit card, etc.), something we know (e.g., computer password, PIN number, etc.), or some unique and measurable biological feature (e.g., our face recognized by a bank teller or security guard, etc.). The most secure means of identity is a biological (or behavioral) feature that can be objectively and automatically measured and is resistant to impersonation, theft, or other fraud. The use of biometrics, which are measurements derived from human biological features, to identify individuals is a rapidly emerging science.

Biometrics include fingerprints, facial features, hand geometry, voice features, and iris features, to name a few. In the existing art, biometric authentication is performed using one of two methodologies. In the first, verification, individuals wishing to be authenticated are enrolled in the biometric system. This means that a sample biometric measurement is provided by the individual, along with personal identifying information, such as, for example, their name, address, telephone number, an identification number (e.g., a social security number), a bank account number, a credit card number, a reservation number, or some other information unique to that individual. The sample biometric is stored along with the personal identification data in a database.

When the individual seeks to be authenticated, he or she submits a second biometric sample, along with some personal identifying information, such as described above, that is unique to that person. The personal identifying information is used to retrieve the person's initial sample biometric from the database. This first sample is compared to the second sample, and if the samples are judged to match by some criteria specific to the biometric technology, then the individual is authenticated. As a result of the authentication, the individual may be granted authorization to exercise some predefined privilege(s), such as, for example, access to a building or restricted area, access to a bank account or credit account, the right to perform a transaction of some sort, access to an airplane, car, or room reservation, and the like.

Conventional verification methodologies have several disadvantages. First, the individual must submit private, personal, identifying information which is stored in a database over which they have little or no control and which may be subject to unauthorized access by individuals intent on using the information to invade the person's privacy, for some profit motive, for some criminal purpose, etc. Second, the person is again required to submit some unique personal identifying information, in addition to their biometric sample, in order to be authenticated. This unique identifying information may be difficult to remember or may be contained on a smart card, credit card, or other token which the individual must have in his or her possession. This requirement constitutes an inconvenience and an undesirable encumbrance to the authentication process. Hence a more convenient form of authentication is needed which also preserves privacy.

The second form of biometric authentication is identification. Like the verification case, the individual must be enrolled in a biometric database where each record includes of a first biometric sample and accompanying personal identifying information which are intended to be released when authentication is successful. In order to be authenticated the individual submits only a second biometric sample, but no identifying information. The second biometric sample is compared against all first biometric samples in the database and a single matching first sample is found by applying a match criteria. The advantage of this second form of authentication is that the individual need not remember or carry the unique identifying information required in the verification method to retrieve a single first biometric sample from the database.

However, it should be noted that successful use of the identification methodology requires extremely accurate biometric technology, particularly when the database is large. This is due to the fact that in a database of n first biometric samples, the second sample must be compared to each first sample and there are thus n chances to falsely identify the individual as someone else. When n is very large, the chance of erroneously judging two disparate biometric samples as having come from the same person is preferably vanishingly small in order for the system to function effectively. Among all biometric technologies only iris recognition has been shown to function successfully in a pure identification paradigm, requiring no ancillary information about the individual. But the identification method still requires the compilation of a central database of personal information which has the same vulnerabilities as those described in the verification case. Thus, there exists a need for a new biometric authentication methodology which overcomes the privacy concerns associated with this database containing personal identifying information. The present invention addresses this need.

### SUMMARY OF THE INVENTION

The present invention is directed to a system and method that use biometrics for anonymous authentication in order to determine whether to grant certain privileges to an individual submitting the biometric. The system and method verify that an individual has the authority to access the privilege or privileges sought. The anonymous biometric authentication system and method provide an improvement over conventional authentication systems in that they do no require that any personal identifying information be stored in a database along with the biometric sample in order to authenticate the identity of an individual.

The anonymous biometric authentication system of the present invention does not require any personal information be captured, collected, or solicited during the authentication process and no other personal information is stored along with the biometric during the enrollment process. Thus, the anonymous biometric authentication system of the present invention solves the privacy concerns associated with conventional authentication systems because it does not require the compilation of a central database containing personal identity information over which the individual has little or no control and that may be vulnerable to unauthorized access.

The system and method of anonymous biometric authentication include an anonymous biometric enrollment system. The anonymous biometric enrollment system including a biometric acquisition device and a first biometric of an individual seeking to be enrolled. The first biometric is captured by the biometric acquisition device. One or more credentials indicative of an identity of the individual may be submitted during enrollment and an enrollment authority verifies an identity of the individual seeking enrollment using the one or more credentials. A “good” database is provided for storing the captured first biometric image. A plurality of first biometrics of individuals enrolled in the anonymous biometric authentication system are stored in the good database. The credentials are not stored in the good database with the first biometric.

Alternatively, the anonymous biometric authentication system can be designed to avoid repeat offenders by capturing a biometric of an individual seeking to exercise a privilege and denying the privilege if the captured biometric is matched to a biometric stored in a database containing the biometrics of previous offenders. In this case, a “bad” database is provided for storing the first biometric of previous offenders.

The privilege can include a single privilege and/or a set of privileges. The privilege(s) can include, for example, access to a building, access to a secure area, cashing a personal check, using a credit card, performing a financial transaction, fulfilling a reservation, and the like.

The anonymous biometric authentication includes an anonymous authentication system that includes a biometric acquisition device, and a second biometric of an individual seeking to exercise a privilege. The second biometric sample is captured using the biometric acquisition device. The anonymous authentication system includes a good database comprising a plurality of first biometrics derived from individuals authorized to exercise the privilege that was previously stored in the good database using the enrollment system. A processor is coupled to the biometric acquisition device for receiving the second biometric and is also coupled to the good database for accessing the first biometrics stored therein. The processor includes a comparator for comparing the second biometric to the first biometrics stored in the good database. An anonymous biometric authentication of an identity of the individual is based on the comparison of the second captured biometric sample to the first stored biometric sample. The privilege is granted to an individual based on a positive anonymous biometric authentication of the identity of the individual indicated by a match of the second biometric to one of the first biometrics stored in the good database. Preferably, the second captured biometric is compared by the processor to all of the stored biometrics in order to verify the identity of the individual.

In addition, the anonymous biometric authentication system can include a transaction request that is received by the processor along with the second biometric. The second captured biometric is compared by the processor to the first biometrics stored in the good database corresponding to the transaction request in order to grant one or more privileges corresponding to the transaction request. The anonymous biometric authentication system also includes a transaction number that is received by the processor along with the second biometric. The transaction number is indicative of a specific transaction of the privilege which is exercised by the individual.

The information stored in the database can be encrypted using conventional techniques, such as public-key and private-key techniques.

The method of anonymous biometric authentication of an individual for granting one or more privileges includes the steps of: submitting a transaction request indicative of a privilege that is sought to be exercised; capturing a biometric of an individual; storing the captured biometric in a memory; comparing the captured biometric to a plurality of enrolled biometrics stored in a database corresponding to the privilege that is being sought to be exercised; anonymously authenticating an identity of the individual based on the step of comparing the captured biometric to the stored biometrics in the good database; and granting the privilege based on the step of anonymously authenticating the individual.

The method of anonymous biometric authentication may further include the step of generating an authorization code based on the step of anonymously authenticating the individual. The method of the present invention may generate an approval authorization code if one of the stored biometrics matches the captured biometric. Alternatively, the method of anonymous biometric authentication may generate one of a rejection authorization code and no authorization code if one of the stored biometrics does not match the captured biometric.

The system and method of anonymous biometric authentication may also include the step of involuntarily revoking the assigned privileges. The step of involuntarily revoking the privileges further comprises the steps of: saving the transaction request and the second biometric in a temporary transaction database; transmitting the transaction request and the second biometric to a verification authority; determining that the individual submitting the second biometric has not been assigned the privilege sought to be exercised; transmitting a revocation code to the temporary transaction database and finding the transaction request and the second biometric in the temporary transaction database; searching the good database to find a matching biometric corresponding to the second biometric; and removing the corresponding first biometric from the good biometric database based on the step of transmitting the revocation code.

The system and method of anonymous biometric authentication may also include the step of voluntarily revoking the assigned privileges. The step of voluntarily revoking the privileges further includes the steps of: receiving a second biometric from an individual seeking to have a privilege voluntarily revoked; searching the good database to find a matching first biometric; and removing the first biometric based on the matching of the voluntarily submitted second biometric to the first biometrics in the good database.

The system and method of anonymous biometric authentication of the present invention preferably use iris patterns as the biometric technology to effectively and anonymously authentication an individual and grant certain privileges based on the anonymous biometric authentication. In one preferred embodiment, the biometric is an iris of an eye and the biometric acquisition device is an iris acquisition device for capturing an image of the iris of the eye of the individual.

The anonymous biometric authentication system can also include a first biometric record and a second biometric record. The first biometric record includes a biometric template extracted from the first biometric and the privilege sought to be exercised. The biometric template portion of the first biometric record binds an identity of the individual to the assigned privilege. The second biometric record includes a biometric template extracted from the captured second biometric, a transaction request for the privilege sought to be exercised, and a transaction number. The biometric template portion of the second biometric record binds an identity of the individual to the transaction request and the transaction number.

### BRIEF DESCRIPTION OF THE DRAWINGS

The foregoing and other aspects of the present invention will become apparent from the following detailed description of the invention when considered in conjunction with the accompanying drawings. For the purpose of illustrating the invention, there are shown in the drawings embodiments that are presently preferred, it being understood, however, that the invention is not limited to the specific methods and instrumentalities disclosed. In the drawings:

FIG. 1 is a schematic diagram of an exemplary anonymous biometric authentication system in accordance with the present invention;

FIG. 2 is a schematic diagram of an exemplary enrollment system for enrolling an individual in the anonymous biometric authentication system of FIG. 1;

FIG. 3 is a schematic diagram of an exemplary authentication system for authenticating the identity of an individual in the anonymous biometric authentication system of FIG. 1;

FIG. 4 is a flowchart illustrating an exemplary enrollment process for enrolling an individual in the anonymous biometric authentication system in accordance with the present invention;

FIG. 5 is a flowchart illustrating an exemplary anonymous biometric authentication process for authenticating the identity of an individual using the anonymous biometric authentication system in accordance with the present invention;

FIG. 6 is a schematic diagram of an anonymous biometric authentication process for an exemplary retail transaction;

FIG. 7 is a schematic diagram of an exemplary involuntary revocation of privileges process in accordance with the present invention;

FIG. 8 is a schematic diagram of an exemplary voluntary revocation of privileges process in accordance with the present invention;

FIG. 9A is a schematic diagram of another exemplary anonymous biometric authentication system for authenticating the identity of an individual in the anonymous biometric authentication system for avoiding repeat offender in accordance with the present invention;

FIG. 9B is a flowchart of an exemplary check credit protection program in accordance with the anonymous biometric authentication system of FIG. 9A;

FIG. 9C is a schematic diagram of the anonymous biometric authentication system of FIG. 9A showing an external data source of previous offenders for authenticating the identity of an individual in accordance with the present invention;

FIG. 10 is a schematic diagram of an exemplary biometric capture system that can be used with the present invention;

FIG. 11 is a flowchart of an exemplary method of capturing a biometric in accordance with the present invention;

FIGS. 12A and 12B are schematic diagrams showing exemplary biometric record structures in accordance with the present invention; and

FIG. 13 is a schematic diagram of an exemplary iris identification system that can be used with the present invention.

### DETAILED DESCRIPTION OF PREFERRED EMBODIMENTS

The present invention is directed to a system and method that use biometrics for anonymous authentication of an individual in order to determine whether to grant certain privileges to the individual submitting the biometric. In one preferred embodiment, the anonymous biometric authentication system includes an enrollment system for enrolling an individual in the anonymous biometric authentication system and an authentication system for identifying the individual and granting one or more privileges based on the authentication. During the enrollment process, an individual submits a first biometric along with personal identification documents that verify the identity of the individual submitting the biometric for enrollment into the anonymous authentication system. After the identity of the individual has been verified using the personal identity documents, only the biometric is stored in a database. During the authentication process, an individual submits a second biometric that is compared to all of first biometrics stored in the database until a single match is found thereby verifying the identity of the individual. As a result of the authentication, the individual may be granted authorization to exercise some predefined privilege(s), such as, for example, access to a building or restricted area, access to a bank account or credit account, the right to perform a transaction of some sort, access to an airplane, car, or room reservation, and the like.

The first voluntarily submitted biometric is stored in a database (e.g., a good database) for later use in anonymously authenticating an individual based on a second voluntary biometric submission. No other personal information is captured, collected, or solicited during the authentication process and no other personal information is stored along with the biometric during the enrollment process. Thus, the anonymous biometric authentication system of the present invention solves the privacy concerns associated with conventional authentication systems because it does not require the compilation of a central database containing personal identity information over which the individual has little or no control and that may be vulnerable to unauthorized access.

The system and method of anonymous biometric authentication of the present invention preferably use iris patterns as the biometric technology to effectively and anonymously authentication an individual and grant certain privileges based on the anonymous biometric authentication.

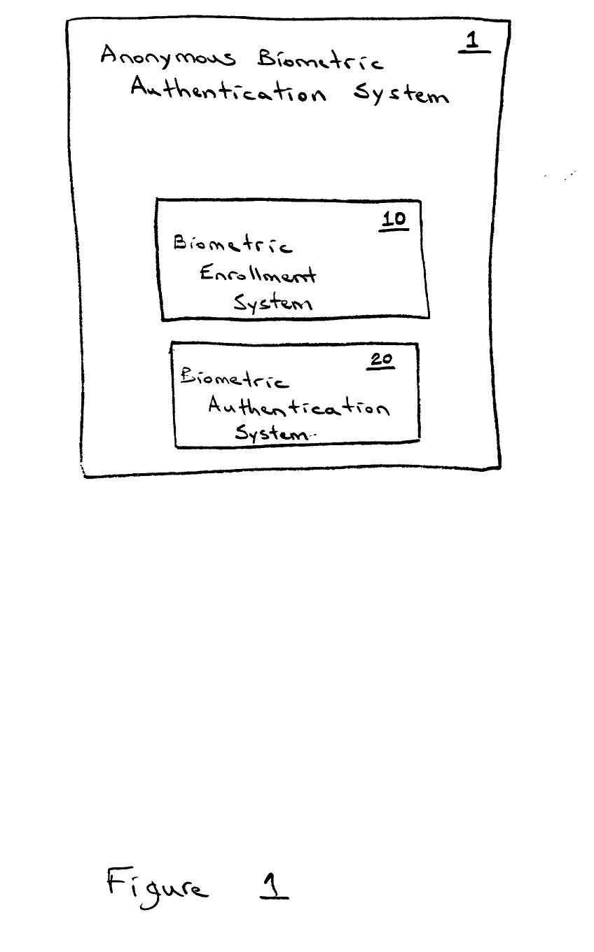

FIG. 1 shows an exemplary anonymous authentication system 1. The anonymous biometric authentication system 1 of the present invention uses biometric technology in order to grant one or more privileges based on the anonymous biometric authentication. As shown in FIG. 1, the anonymous authentication system 1 includes an enrollment system 10 for enrolling an individual and assigning a privilege or set of privileges, and an authentication system 20 for positively identifying the individual seeking to exercise the assigned privilege(s).

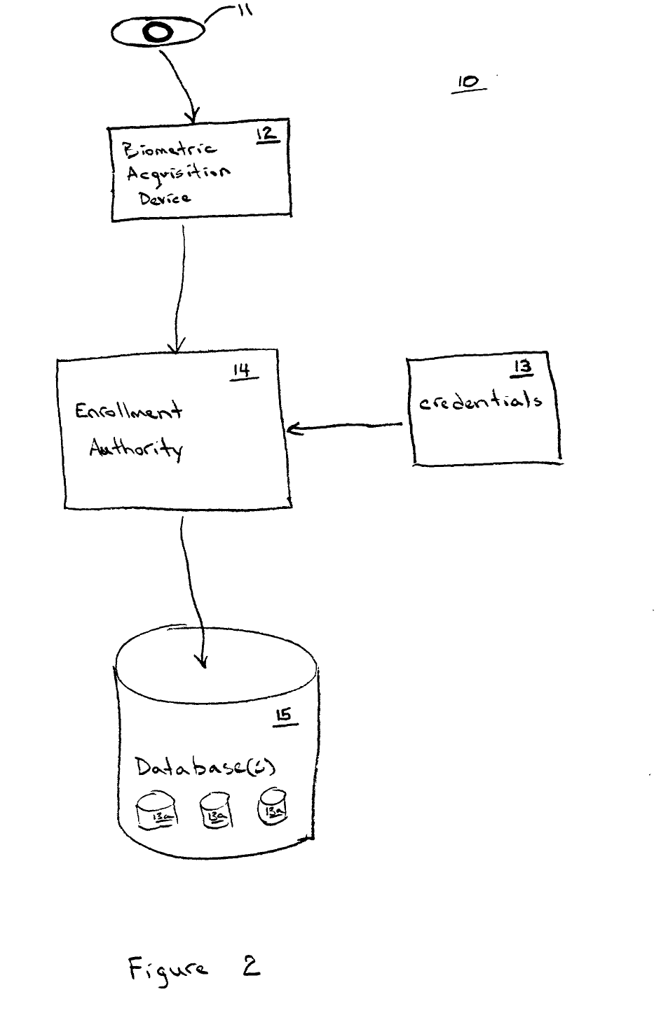

FIG. 2 shows an exemplary biometric enrollment system 10. As shown in FIG. 2, the enrollment system 10 includes a first biometric 11 of an individual and a biometric acquisition device 12 used to capture a biometric sample 11. The biometric 11 can include, for example, an iris of an eye, fingerprints, facial features, hand geometry, voice features, and the like. Preferably, the biometric is an iris of an eye and the biometric acquisition device 12 captures an image of the iris.

As shown in FIG. 2, the enrollment system 10 can also include identification documents or credentials 13 that verify the identity of the individual submitting the biometric 11 during the enrollment process. For example, the credentials 13 may include a driver license, bank card, credit card, etc., or his or her face recognized by a bank teller or other official, etc. Preferably, the credentials 13 of an individual are verified at the time that the biometric is captured during enrollment.

An enrollment authority 14 may be responsible for verifying the credentials 13 of an individual at the time of enrollment. The enrollment authority 14 can include a central anonymous biometric authentication system administrator or may include the organization responsible for assigning and administering a specific privilege that is being sought by the individual, such as a financial institution, a bank, a check cashing agency, a retail establishment, a restaurant, a travel agency, a hotel, a car rental agency, an airline, and the like.

The enrollment system 10 includes one or more databases 15 that are used to store one or more captured biometrics 11. As shown in FIG. 2, the enrollment system 10 can include a central database 15 that is used to store a plurality of captured biometrics 11. Once the biometric 11 has been captured and the credentials 13 of an individual have been verified by the appropriate enrollment authority 14, then the biometric 11 is stored in a “good” database 15 for later use by the biometric authentication system 20 in identifying an individual based on a comparison of a later submitted biometric to the biometrics 11 stored in the good database 15. No other personal identification information is stored in the good database 15 with the biometrics 11. This helps to ensure the privacy of individuals enrolled in the anonymous biometric authentication system 1.

The anonymous biometric authentication system 1 can include good database for storing the biometric sample 11 (e.g., iris image) of individuals who are enrolled in a particular application and have been granted the authority to exercise a particular privilege and/or set of privileges. Accordingly, all individuals having biometrics 11 that are contained within a specific database have been approved for the privilege or set of privileges specified by that database. The good database 15 can include a central database having a plurality of partitions 15a for different privileges or sets of privileges, as shown in FIG. 2. Alternatively, the database 15 can include a plurality of individual databases, one for each specific privilege or set of privileges. Furthermore, the biometric sample 11 is preferably encrypted or otherwise converted to some form prior to storing it in the database 15 such that it cannot be used to determine the person's identity simply by examining the biometric 11 alone.

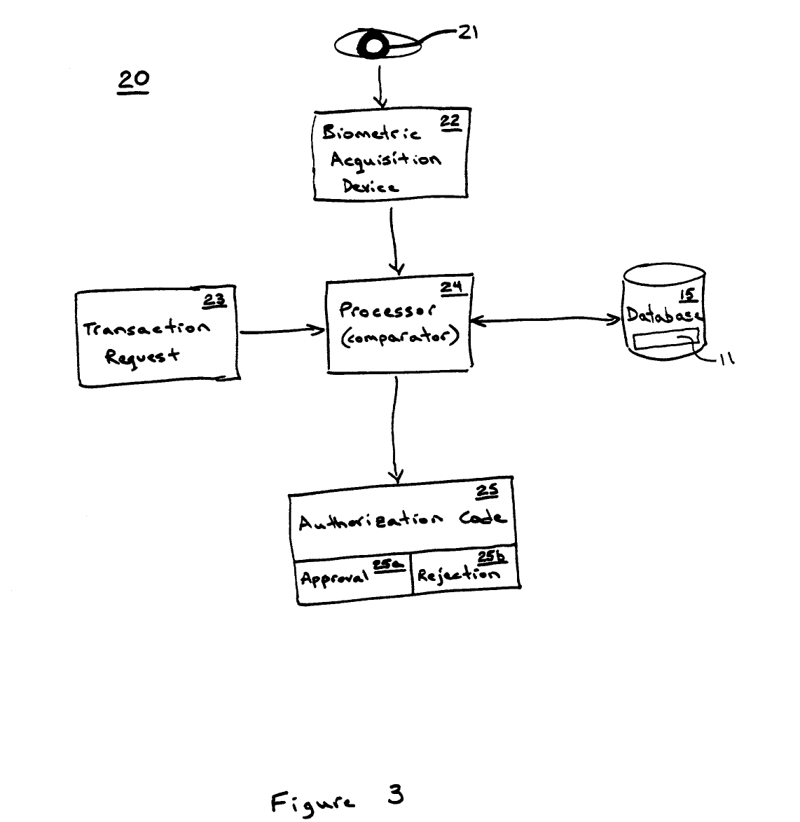

FIG. 3 is an exemplary authentication system 20 for the anonymous biometric authentication of an individual seeking to exercise one or more assigned privileges. As shown in FIG. 3, the authentication system 20 includes a second biometric 21 of an individual, such as, for example, an iris of an eye, and a biometric acquisition device 22 that is use to capture the second biometric 21. The biometric acquisition device 22 may be the same biometric acquisition device that was used in enrollment system 10, although it need not be.

When an individual desires to exercise a certain privilege or set of privileges, then that individual submits a transaction request 23 designating the privilege sought along with the second biometric sample 21. The transaction request 23 may be used as a pointer to a specific database 15 or to a database partition 15a containing the stored biometrics 11 for the designated privilege that is being sought to be exercised by the individual.

The authentication system 20 includes a processor 24 for comparing the second biometric 21 to one or more of the first biometrics 11 stored in the database 15. Preferably, the biometric authentication system 20 performs the anonymous authentication using an identification methodology.

In a preferred embodiment using the identification methodology, the anonymous biometric authentication is performed by comparing the second biometric 21 to all the biometrics 11 stored in the good database 15. This allows an individual to be anonymously authenticated by submitting a second biometric 21 only, but no identifying information or credentials. The processor 24 accesses the stored biometrics 11 in the database 15 and compares the second captured biometric 21 to all of the stored biometrics 11 in the database 15 until a single matching first biometric 11 is found, preferably using conventional matching techniques.

If a positive match is found, then the identity of the individual is authenticated. An authorization code 25 is generated based on the results of the comparison of the second biometric 21 to the first biometrics 11 stored in the database 15. Once the comparison is complete, then an authorization code 25 is generated by the processor 24. Preferably, if a positive match is found, then an approval authorization code 25a is generated and if no match is found, then a rejection authorization code 25b, or no code, is generated.

The anonymous biometric authentication system 1 presumes that upon enrollment, individuals can be assigned a privilege and/or a certain set of privileges which might be specific to the individual and/or in common to a large number or group of individuals, and that the result of authentication is to grant the individual those assigned privileges. The privileges might include, for example, access to a building, writing of a personal check, using a credit card at a retail establishment, performing some type of business or personal financial transaction, fulfilling a reservation, and the like. Each of these specific and/or standard privileges can be associated with one or more good database(s) 15 containing stored biometrics 11 of the individuals enrolled to use the assigned privilege(s). Preferably, separate database(s) 15 or database partitions 15a are provided for each standard privilege or each group of standard privileges. For example, the privilege or privileges may include access to a physical space (e.g., a building or a restricted area), use of a computer, access to a bank account or credit account, the right to perform a transaction of some sort, to cash a check or use a check for payment, access to an airplane, car, or room reservation, and the like.

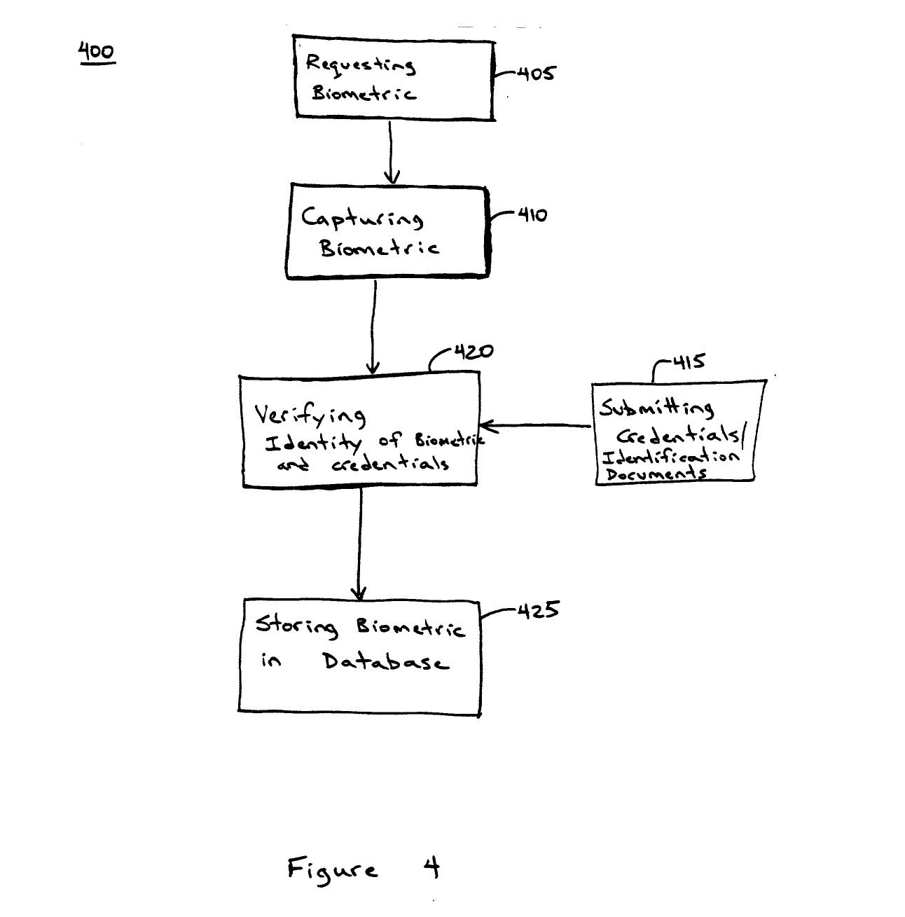

FIG. 4 is a flowchart illustrating an exemplary enrollment process 400 of an individual seeking the privilege of using a credit card in a retail transaction. As shown in FIG. 4, the enrollment process 400 includes requesting an individual to submit a biometric, at step 405, in order to be enrolled in the anonymous biometric authentication system for the privilege of using a credit card to complete a retail transaction; capturing the biometric of the individual using a biometric acquisition device, at step 410; and receiving credentials or personal identifying documents submitted by the individual, at step 415, along with the captured biometric. Preferably, the biometric sample is encrypted or otherwise converted to some form such that it cannot be used to determine the person's identity simply by examining the biometric alone. Verifying the identity of the individual submitting the biometric and seeking the specific privileges, at step 420, relying on the credentials submitted by the individual. Once the identity of the individual has been verified using the credentials, the biometric, and preferably the biometric only, is stored in a good database, at step 425. Preferably, the biometric is stored in a database or database partition for the specific privilege or set of privileges sought by the individual. The credentials are preferably returned to the individual or discarded after the identity of the individual is verified and the biometric has been stored in the database.

As shown in FIG. 4, except for the documents that verify identity or credentials, submitted at step 415, along with the first biometric sample captured at step 410, no other personal or identity information is captured, collected, or solicited. Also, once the credentials have been verified, at step 420, by, for example, an enrollment authority (e.g., a financial institution responsible for issuing the credit card), then the credentials are returned or discarded and are not stored with the first biometric in the good database, at step 425, for which the individual has been assigned/granted privileges. Again, no personal information is stored along with the first biometric sample.

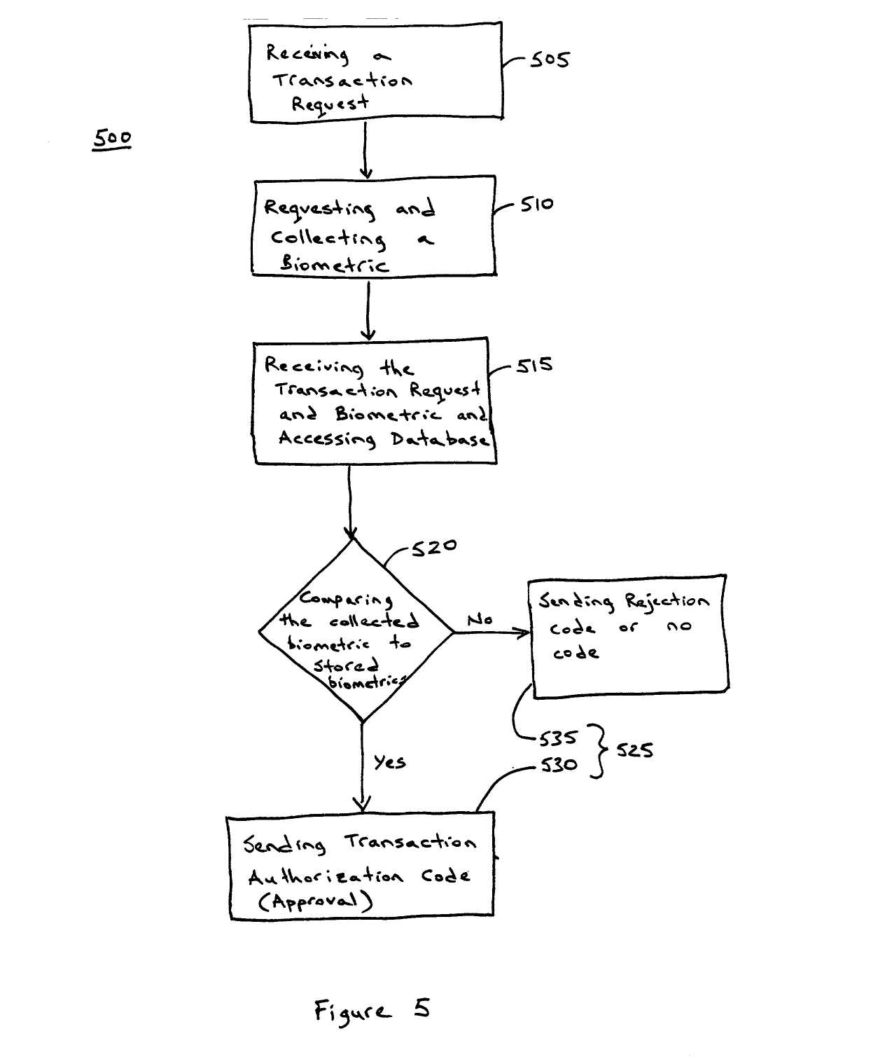

FIG. 5 shows an exemplary authentication process 500 for a retail transaction. As shown in FIG. 5, when an individual seeks to be authenticated in order to exercise one or more privileges described above, such as approval to use a credit card, a transaction request (e.g., the privilege sought) is received from the individual seeking to exercise the privilege, at step 505, and a second biometric sample is requested and collected/captured, at step 510. A processor receives the transaction request and the second biometric submission and then accesses the good database of stored biometrics for the privilege sought, at step 515. Preferably, the transaction request is used as a pointer to point to the appropriate database or database partition for the privilege sought, however, it need not be. The second biometric is compared, at step 520, against the biometrics previously stored in the good database and corresponding to the desired privilege(s).

Preferably, an identification methodology for authenticating the individual is used, especially where there is a relatively large number of biometrics stored in the database. This can obviously be repeated for additional databases or for different database partitions if additional privileges are requested. An authentication code is returned, at step 525, based on the comparison performed at step 520. Preferably, the only information returned by the anonymous biometric authentication system 1 is whether the identity of the individual has been authenticated. Preferably, an approval authorization code is generated, at step 530, if the identity of the individual has been successfully authenticated and, a rejection code or no authorization code is generated, at step 535, if no match is found. Because there is no usable personal information contained in the database, security of the personal identity information of the individual is greatly enhanced and the personal privacy concern associated with conventional identification systems is greatly diminished.

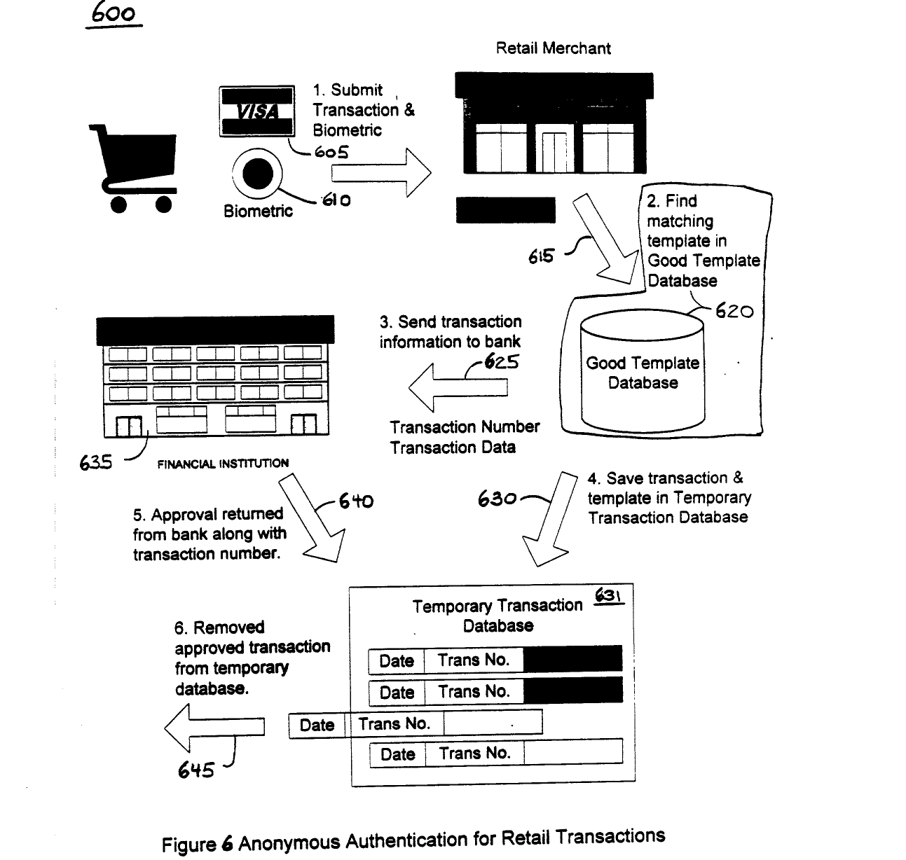

FIG. 6 shows an exemplary retail transaction 600 involving an individual seeking to use or exercise the privilege of writing a check or using a credit card to complete the retail transaction. As shown in FIG. 6, an individual submits and the anonymous biometric authentication system receives a transaction request, at step 605, and a biometric sample, at step 610. After acquiring the transaction request and the biometric, the retail merchant transmits this information to a system server and/or system administrator where the information is received, at step 615. The system server includes a processor that receives the transmitted biometric and transaction request. The processor accesses the appropriate good database containing the previously stored biometrics, at step 620. Preferably, the transaction request is used by the processor to point to a specific database or database partition containing previously collected and stored biometrics corresponding to the privilege sought by the individual, as indicated by the transaction request. Also, at step 620, the processor compares the second biometric to the biometrics stored in the appropriate good database for the privilege sought.

If authenticated, the transaction is processed and the individual is permitted to exercise the privilege requested (e.g., to use a check or credit card to complete the retail transaction). If the identity of the individual is not authenticated, then the individual is not permitted to exercise the privilege.

In addition, if the identity of the individual is authenticated, then a unique transaction number is preferably generated and transmitted, at step 625, to, for example, a bank, credit card company, or financial institution. The information transmitted to the bank can include, for example, the transaction number, the transaction date, the transaction type, etc. As shown in FIG. 6, a copy of the submitted biometric, along with the transaction number, may be stored in a secure temporary transaction file or database 631, at step 630.

The transaction is reviewed by the bank, at step 635, for approval and verification that the individual was authorized to exercise the privilege and that the individual is able to complete the transaction (e.g., that the individual has an account with the bank, has sufficient funds to cover the transaction, etc.). As shown in FIG. 6, an authorization code, including a transaction number, authorization code (e.g., approval or rejection), etc. can be returned to the retail merchant and/or the secured temporary transaction file or database, at step 640. Approved transactions can be removed from the temporary transaction database, at step 645. Alternatively, instead of the bank returning an authorization code, the temporary transaction database 631 may be reviewed periodically, and temporary transaction files which have aged long enough to assure that approval has occurred can be deleted along with their second submitted biometrics.

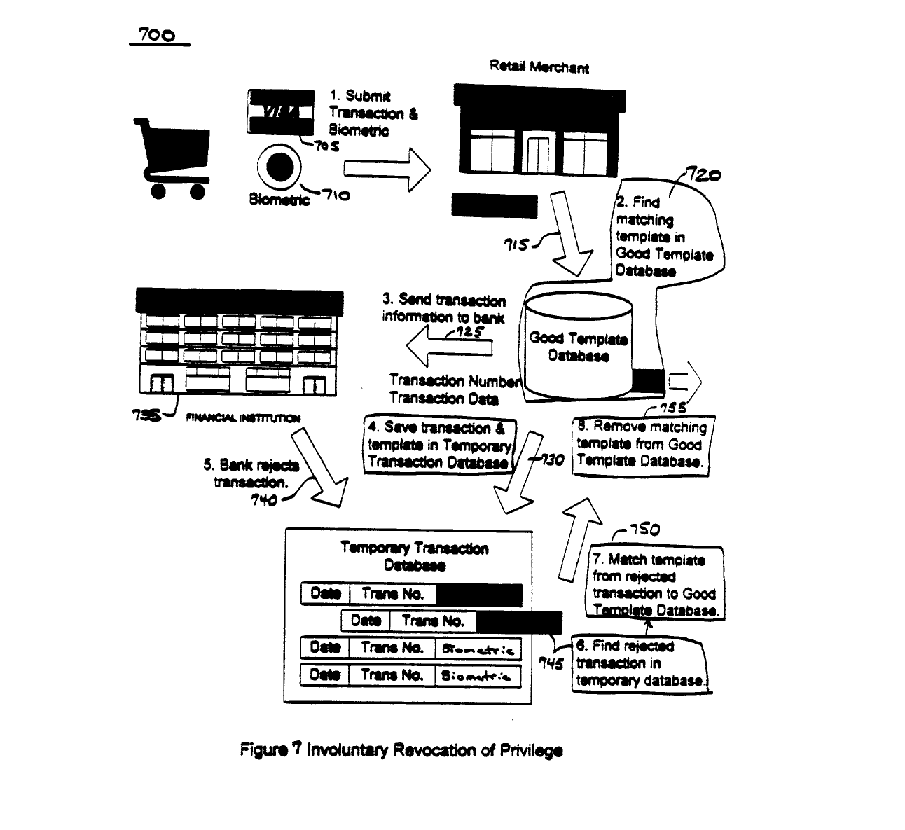

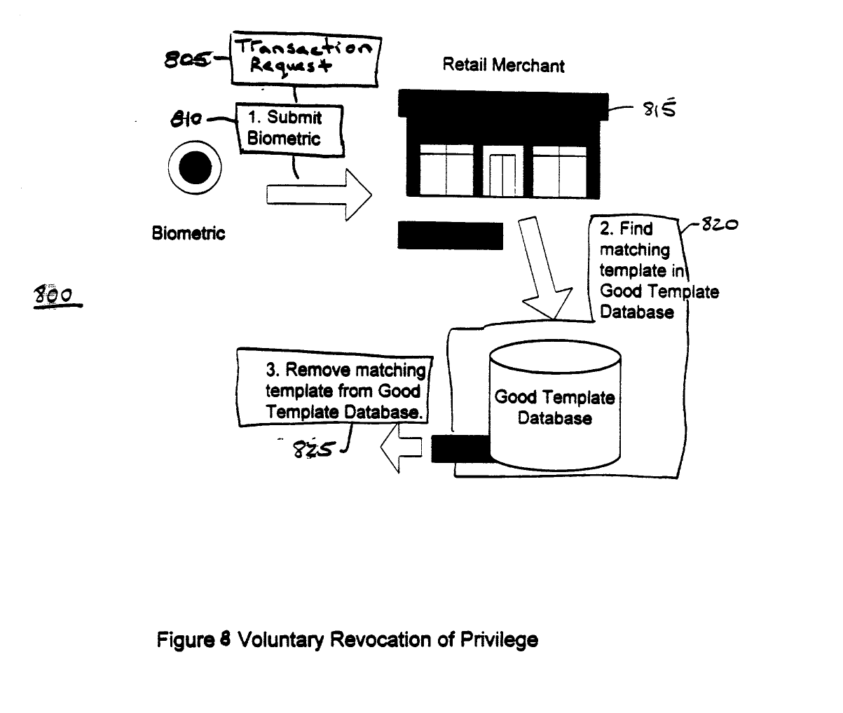

FIGS. 7 and 8 show various additional systems and methods for revoking an assigned privilege and/or removing individuals from the good database 15, either at the request of the individual and/or when that particular privilege is revoked for some reason, such as credit limit exceeded, credit expired, lack of funds to cover a check, failure to fulfill a reservation, and the like. An individual may be removed from the privilege or good database 15 either involuntarily and/or voluntarily.

FIG. 7 shows an exemplary involuntary revocation of privileges process 700 that involuntarily revokes the privileges of an individual from the anonymous biometric authentication system 1. As shown in FIG. 7, a transaction request and biometric are submitted and received, at steps 705 and 710, in a manner similar to that described with reference to FIG. 6. A retail merchant transmits this information to the anonymous authentication system, at step 715, where the information is used by a processor to access the good database and compare the second biometric to the stored biometrics, at step 720. The transaction information is transmitted to a verification authority, such as a bank or financial institution, at step 725 for verification and authorization of the requested privilege, at step 735. The transaction information is also transmitted to a temporary transaction database, at step 730.

If the transaction is refused by the bank or credit card company, notification of same may be transmitted by the bank to the anonymous biometric authentication system 1, at step 740. The rejection code is received along with the transaction number for the transaction which was refused and the corresponding transaction number is found in the temporary transaction database, at step 745. This initiates the process of involuntary privilege revocation. The second biometric associated with the rejected transaction is found in the temporary transaction database, and the second biometric of the rejected transaction is compared against the biometrics in the good database, at step 750. The matching first biometric can be found and deleted from the good database, at step 755. Finally, the transaction number and second submitted biometric can be destroyed, if desired. Alternatively, a record of the rejected transaction number might be retained to document the reason for privilege revocation and removal of the individual's biometric from the good database. Accordingly, if the individual attempts to exercise the privilege at a later date, the request will be denied because no matching biometric will be found in the good database.

For certain other applications the privilege revocation process may be simpler. FIG. 8 shows an exemplary voluntary revocation process 800. As shown in FIG. 8, if the individual whose privilege(s) is to be revoked is available and cooperative, a transaction request is generated to voluntarily revoke certain specified privilege(s), at step 805, and a second biometric is voluntarily collected from the individual, at step 810. The transaction request and the second biometric can be collected from, for example, a retail merchant, or a system administrator of the anonymous biometric authentication system, at step 815. Preferably, the transaction request is used to point to a database or database partition having certain privileges. The second submitted biometric is matched against the biometrics stored in the appropriate privilege database, at step 820. The matching first submitted biometric can then be deleted from the privilege database, at step 825. This might occur, for example, when the privilege is associated with a particular job function and a change in job position or termination of employment necessitates a change in privileges. Also, this may occur where an individual cancels a credit card or changes his or her bank.

The embodiment described above is designed to allow an individual the opportunity to exercise a particular privilege or set of privileges only if he or she is identified by matching the second biometric to biometrics stored in the good database and to deny the individual the opportunity to exercise the privilege if no match is found. In addition, the application described above is intended to be representative, but not the only possible use of the anonymous biometric authentication methodology of the present invention. For example, instead of a financial transaction at a retail merchant, as shown in FIG. 6, the anonymous biometric authentication system could also be used at an international border crossing, and the good database could contain biometric information on approved travelers.

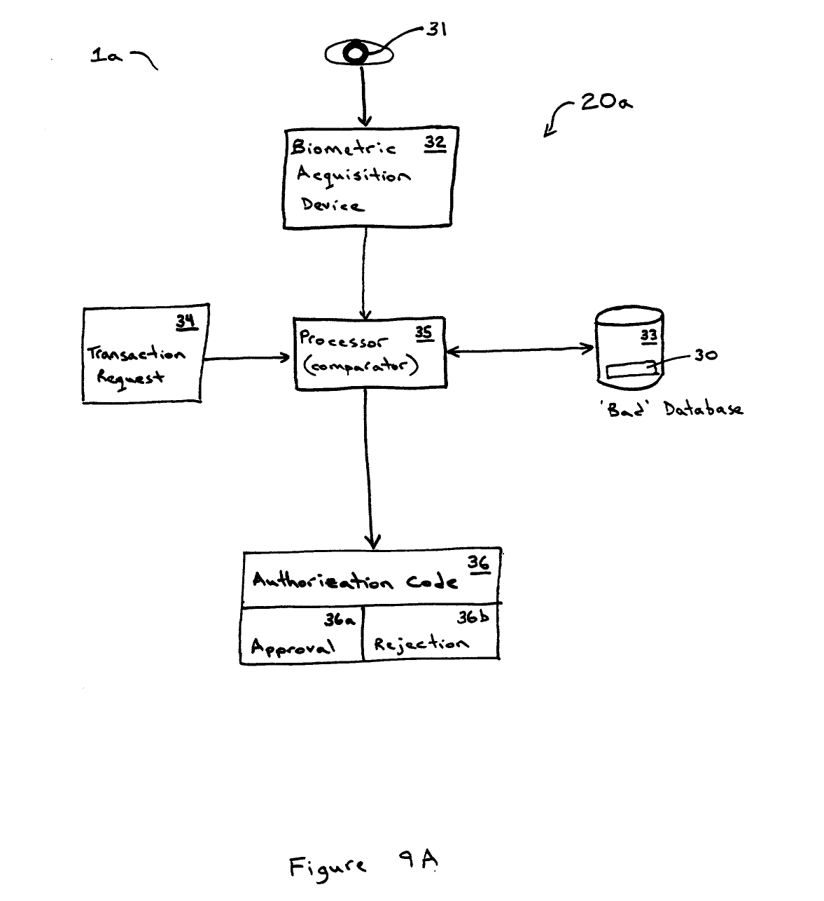

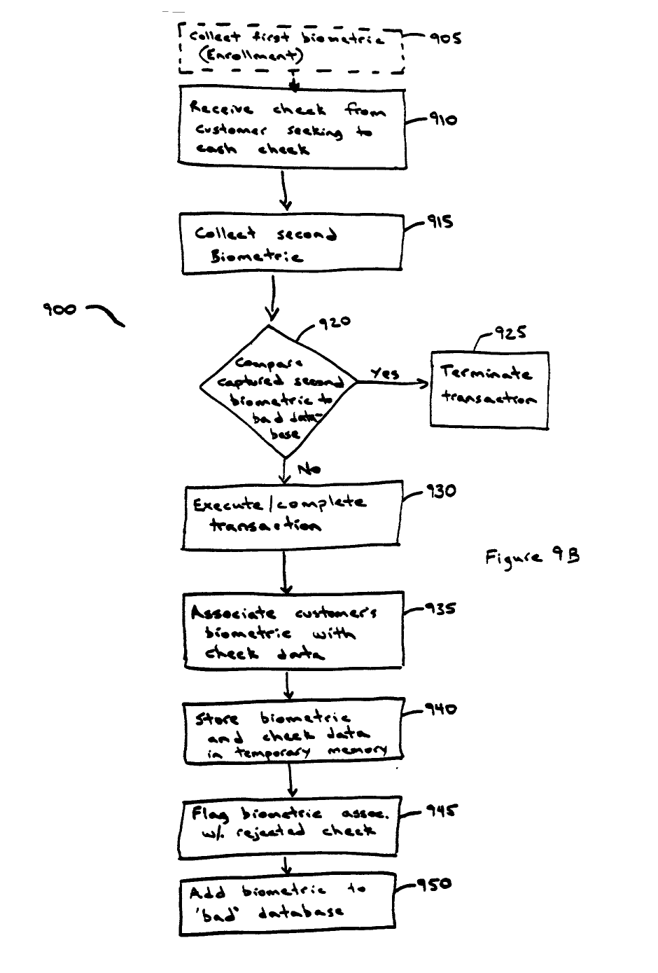

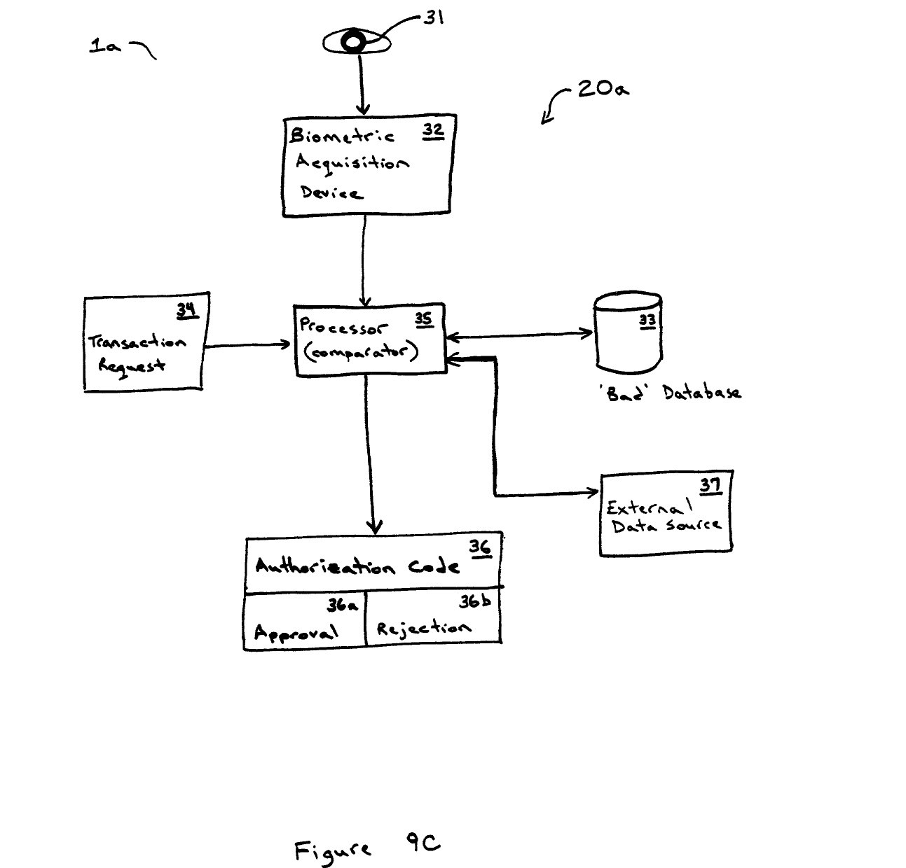

In another embodiment, the anonymous biometric authentication system 1a can be constructed such that the main goal is to avoid “repeat offenders.” FIG. 9A shows an exemplary anonymous biometric authentication system 1a constructed to avoid repeat offenders. As shown in FIG. 9A, the anonymous biometric authentication system la includes a second biometric 31 of an individual, such as, for example, an iris of an eye, a biometric acquisition device 32 that is use to capture the second biometric 31, and a “bad” database 33. The bad database 33 includes previously flagged biometrics of individuals who conducted a fraudulent transaction (e.g., a previous offender). This may include an individual who exercised a privilege that he or she was not assigned (e.g., cashing a stolen check), an individual that is unable to complete a transaction (e.g., insufficient funds), and/or an individual who has had his or her privilege(s) revoked.

When an individual desires to exercise a certain privilege or set of privileges, then that individual submits a transaction request 34 designating the privilege sought along with the second biometric sample 31. The transaction request 34 may be used as a pointer to a “bad” database 33 or to a database partition 33a containing the stored biometrics 30 for the designated privilege that is being sought to be exercised by the individual.

In this alternate embodiment designed to prevent repeat offenders, the anonymous biometric authentication system 20a includes a processor 35 for comparing the second biometric 31 to one or more of the first biometrics 30 stored in the bad database 33. Preferably, the biometric authentication system 20a performs the anonymous authentication using an identification methodology.

In a preferred embodiment using the identification methodology, the anonymous biometric authentication is performed by comparing the second biometric 31 to all the biometrics 30 stored in the bad database 33. This allows an individual to be anonymously authenticated by submitting a second biometric 31 only, but no identifying information or credentials. The processor 35 accesses the stored biometrics 30 in the bad database 33 and compares the second captured biometric 31 to all of the stored biometrics 30 in the bad database 33 until a single matching first biometric 30 is found, preferably using conventional matching techniques.

If a positive match is found, then the identity of the individual is authenticated. An authorization code 36 is generated by the processor 35 based on the results of the comparison of the second biometric 31 to the first biometrics 30 stored in the bad database 33. Preferably, if no match is found, then an approval authorization code 36a, or no code, is generated and the individual is allowed to exercise the privilege. If a positive match is found, then a rejection authorization code 36b is generated and the individual is denied the privilege.

For example, in an exemplary check cashing application 900 shown in FIG. 9B, it can be understood that under most fraud prevention programs, the offender is typically identified as a fraud only after the first transaction in which his or her check is returned by the bank as “unaccepted” for whatever reason. In this exemplary application, the client would be the check cashing agency or agencies, the assigned privilege would be the right to cash a check, and the biometric could be an iris of an eye.

An exemplary check credit protection program 900 is shown in FIG. 9B. Upon receiving a check presented at the client's cash register, at step 910, the customer will be requested to provide his or her iris for collections at step 915. At that point, the captured biometric is compared, at step 920, to one or more biometrics stored in a “bad” database containing the first biometrics of previously submitted biometrics that are associated with a failed or rejected transaction. If a match is found, at step 920, between the stored biometrics in the bad database and the captured biometric, then the privilege is denied and the transaction is terminated, at step 925. For example, in the application shown in FIG. 9B, wherein an individual is trying to cash a check, if a stored biometric matches the captured biometric, then the individual is not allowed to cash the check. If a match is not found, at step 920, then the individual is permitted to exercise the privilege and the transaction is completed, at step 930. For example, in the application shown in FIG. 9B, wherein an individual trying to cash a check, if no stored biometric matches the captured biometric, then the individual is allowed to cash the check.

In addition, the check writing customer's iris can be associated, at step 935 with the check and the data thereon being presented. The data on the check is typically the bank customer's name, address, bank account number, and sometimes telephone number. The bank may have additional information. The biometric and check data can be stored in a temporary memory at step 940. If the transaction is later identified as being fraudulent (e.g., the check is returned because it is a fraud or there are insufficient funds, for example), then the captured second biometric is flagged, at step 945. The flagged biometric can be added to the bad database, at step 950, for later retrieval in authenticating the identity of individuals during subsequent transaction requests, and that individual would have no further check writing privileges at that store or any of the client's affiliated stores. The cycle of the check credit protection program would thus be complete.

Note, in the case of a stolen check, this data is still useless, because it does not identify the person presenting the check. However, the client now has the dishonest customer's iris and will be able to identify that customer the next time he or she tries to present a check to the client even though the client does not know the offender's name. Thus, the goal of stopping repeat offenders is achieved.

This embodiment of the anonymous biometric authentication system 900 also provides a secondary benefit to an innocent customer. If a check is a stolen check, then the legal owner of the account can prove he or she is not associated with the fraudulent check presentation by presenting his or her iris. For example, if this later submitted biometric does not match the stored biometric associated with the fraudulent transaction, then the innocent customer may have his or her account credited.

Note that, preferably, the innocent customer will not be flagged because the focus is on the iris of the dishonest customer. Even if the client does not discover the actual identity of the guilty customer, the client will never again be a victim of the guilty customer. The identity of the guilty customer is only necessary if the client is interested in prosecuting the dishonest customer. If the goal is to avoid a repeated theft, the system is complete here.

Furthermore, another benefit of this embodiment of the anonymous biometric authentication system may be that the mere existence of the system may deter first time offenders, because the marginally dishonest customer will know that he or she can now be positively identified later.

In the above described embodiment shown in FIGS. 9A and 9B, the anonymous biometric system la acts as a “repeat” offender security measure for a client who is using internal data only and is not linked to an outside data base.

As shown in FIG. 9B, this embodiment of the anonymous biometric authentication system 1a can include an optional enrollment step. Each customer (e.g., individual) desiring to cash a check enrolls his or her iris anonymously with the store (e.g., the client), at step 905. The enrolled biometric is stored in a good database. Preferably, no customer identification is required to enroll. The simpler and less obtrusive the enrollment process, the better the customer may feel. The good database and the bad database may include one or more partitions within a single database system.

Identifying bank information maybe obtained later when the customer presents the check at the cash register in a store. One reason for this is because enrollment information can be false anyway, such as when a customer may be trying to conceal his or her identity. As described, the real function of the anonymous biometric authentication system 1a is to identify dishonest customers/irises, regardless of the name used to enroll in order to avoid repeat offenders.

The inducement to enroll could simply be that a check writer must enroll to have the privilege of paying by check. In addition, a discount program could be implemented as an inducement for customers to enroll.

FIG. 9C shows another exemplary embodiment of the anonymous biometric authentication system, further including external data source 37 having data relating to prior transactional history of individuals. The data stored in external data source 37 may be accessed by the anonymous biometric authentication system in an effort to prevent a first time fraudulent transaction, in addition to repeat offenders. For a customer registering for the first time under his or her real name, or an alias, his or her identification cannot stop the first fraudulent transaction from occurring, unless data from outside credit agencies 37 is accessed, such as, for example, data compiled by companies, such as TeleBank, CheckAgain, and the like, and indicative of persons who have prior records as fraudulent customers (e.g., previous offenders).

Alternatively, the anonymous authentication system can be connected to an outside credit agency or data source 37 and if it is an “honest” customer who presents his or her real name (no alias) and just has a bad credit rating, the outside credit agency can flag him or her on the first transaction at the client's store. However, even in this embodiment wherein the anonymous authentication system is connected to an outside credit agency, the outside credit agency may preferably also rely upon the repeat offender. Outside credit agencies provide an advantage in that they typically have a head start over the anonymous biometric system because they typically have contracted previously with many clients who share the historical data through a connected network system, again such as TeleBank and CheckAgain.

In embodiments where the client might be interested in catching the first time offender, the client could contract with an outside check cashing agency or agencies 37. Alternatively, the anonymous biometric authentication system could be connected with the outside check cashing agencies, via for example a network connection, so that a standard credit check can be run based on the name (and possibly, alias) presented by the customer to the client at the cash register, such as in check cashing step described below.

Preferably, the biometric technology employed is capable of exhaustive, one to-many searching without requiring submission of any ancillary personal identity information. It is also preferable that the biometric technology be capable of identifying one and only one matching biometric in the good database. Some biometrics when used in a oneto-many search mode identify an array of “candidate” matches. If this array contains at least one entry, the privilege may be granted, albeit with a lesser degree of assurance that this is indeed the correct match. Also, when the good biometric database is searched to remove a biometric, a false match will result in the wrong biometric being removed, which is both an inconvenience to the legitimate user whose biometric was removed and a danger to the privilege-granting authority because the invalid user's privilege was not revoked. Hence some weaker biometrics may not be appropriate for use in the anonymous biometric authentication system.

In a preferred embodiment of the present invention, the biometric is an iris of an eye. The iris is preferred because it is the one biometric that has been proven to be highly reliable when using the identification methodology of authenticating the identity of an individual, especially where a relatively large number of biometrics are involved. Iris recognition also allows fast database searching of a relatively large database.

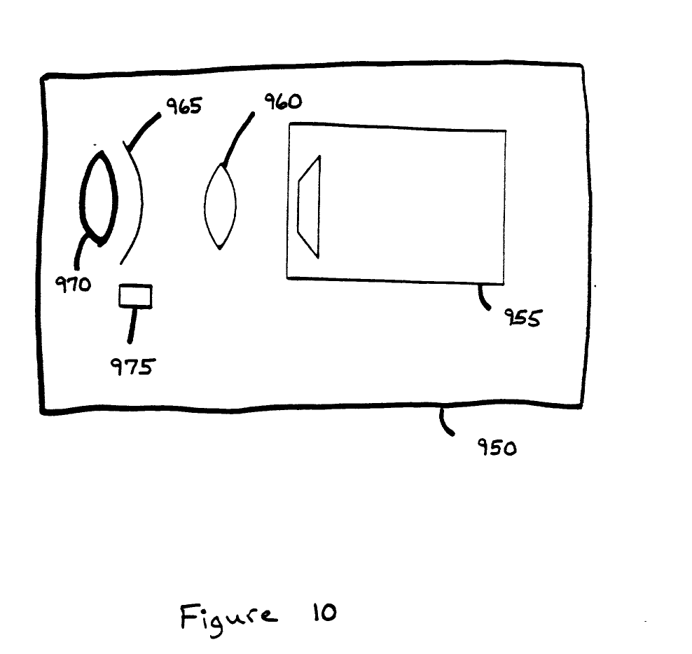

FIG. 10 shows an exemplary biometric image acquisition device 950 that can be used for capturing an image of a biometric trait of the individual. As shown in FIG. 10, the biometric image acquisition device 950 can include an iris imager adapted for capturing an image of the iris of an eye of the individual seeking certain privileges. The captured biometric image is processed to extract a biometric template. As shown, the exemplary biometric image acquisition device 950 comprises iris image capture or acquisition device 955, an imaging lens 960, a mirror 965, an optional diopter correction lens 970, and an illuminator 975. The biometric image acquisition device 950 is connected to the processor by standard wired or wireless connection techniques.

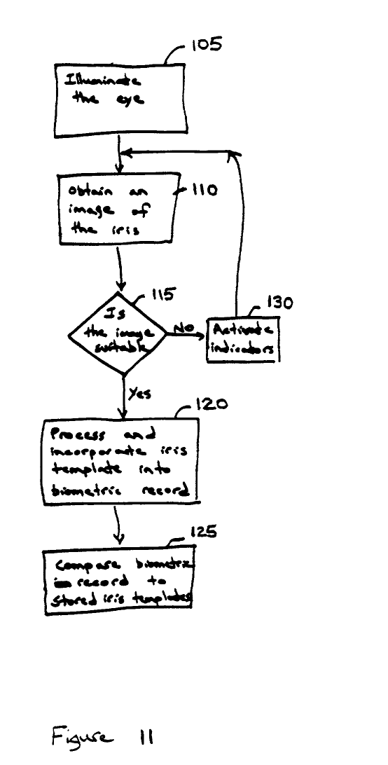

FIG. 11 is a flow chart of an exemplary method of capturing a biometric for use with the present invention. FIG. 11 illustrates an exemplary biometric acquisition process 100 for capturing an image of an iris of an eye of an individual. As shown in FIG. 11, an eye is illuminated at step 105 and an image of the iris is obtained at step 110. At step 115, it is determined if the image is suitable for use with the image processing and comparison routines. If the image is suitable, the image is passed to the processor for further processing, at step 120, and comparison, at step 125. If the image is not suitable, at step 115, the indicator(s) may be activated (e.g., a beep sound is issued) at step 130, and processing continues at step 110 (i.e., another image is obtained).

In accordance with one embodiment of the present invention, image processing algorithms are used to extract a fixed length template (e.g., about 512 bytes long) from each iris image. Iris images are compared by determining the percentage of bits in each template that match. If the percentage of bits that match exceeds a predetermined threshold (e. g., 75%), then it is determined that the iris images being compared belong to the same iris, thereby identifying the subject being tested.

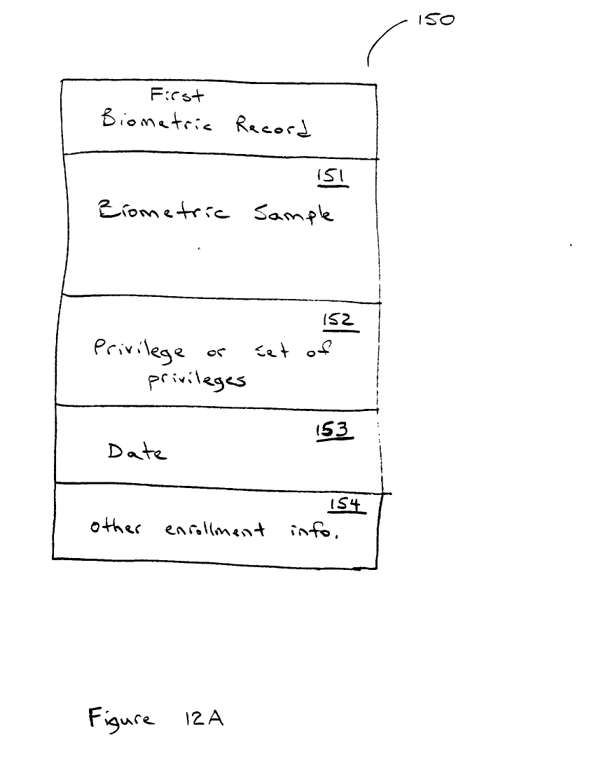

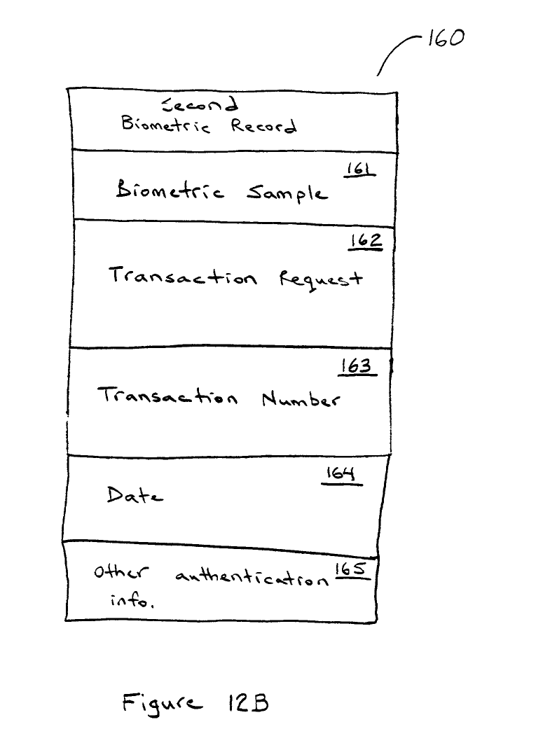

FIGS. 12A and 12B show the formation of exemplary biometric records 150 and 160. A first biometric record 150 is formed at the time of enrollment and a second biometric record 160 is formed at the time of authentication. As shown in FIG. 12A, the first biometric record capturing the enrollment information can include one or more of a first biometric sample 151, such as an iris template, the privilege 152 that has been assigned to the individual, the date of enrollment 153, and other information 154 relating to enrollment. The first biometric record can then be stored in database 15. Preferably, the first biometric is stored in a separate database or in a database partition specific for that privilege. As shown in FIG. 12B, the second biometric record 160 capturing the anonymous authentication process can include one or more of a second biometric sample 161, such as an iris template, a transaction request 162 which corresponds to the privilege that is being sought to be exercised, a transaction number 163, the date 164, and other information 164 relating to the transaction and/or privileges sought. In this manner, the transaction request which corresponds to the privilege sought can acts as a pointer into the appropriate database or database partition. The transaction number 163 can include, for example, a check number, a credit card number, and the like.

The biometric templates 151 and 161 are extracted from the biometric image collected from the individual at one of enrollment and authentication. As will be discussed later, the biometric templates 151 and 161 are preferably an IrisCode® template which is a fixed-length 512-byte code that captures the unique identifying traits contained in the image of the iris. It provides incontrovertible evidence of the identity of the individual being enrolled or requesting certain privileges. Additional entries can further document the transaction and the privileges that are being granted such as, for example, the date and time of the transaction request, the source of the transaction request, the privilege or privileges granted, etc. Preferably, the complete biometric record 150, 160 can be encrypted prior to transmission and/or storage. Encryption can be with any of the known encryption techniques, such as using public and private keys to encipher and decipher the data, respectively.

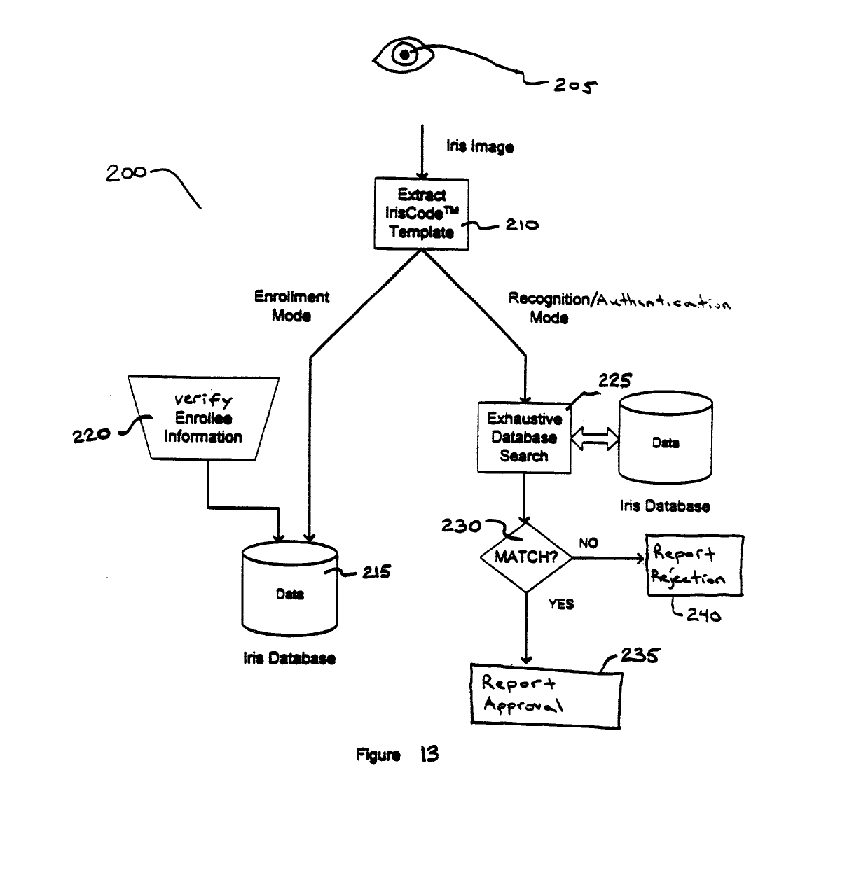

The role of the biometric authentication technology is to bind the identity of the individual to the privileges sought. This can be accomplished in accordance with the exemplary flowchart of FIG. 13 which shows an exemplary anonymous biometric authentication system 200 that uses iris recognition as the biometric. As shown in FIG. 13, an image of an iris of an eye is captured, at step 205. An unique biometric template (e.g., an IrisCode® template) is extracted from the captured image of the iris of the eye, at step 210.

Iris recognition is widely acknowledged as the most powerful and accurate biometric available today. The iris image is collected and processed at the time the transaction request is generated, and can be compared to a database of stored templates collected under controlled conditions by a trusted enrollment agent. This provides absolute and incontrovertible evidence of the individual submitting the biometric for enrollment or authentication.

The iris is a protected internal organ that is at the same time readily available for outside observation. Its complex textural pattern of striations, crypts, rings, furrows, etc., has extremely high information content, yet is stable from about the age of one year throughout life. Notably, the iris structures are formed with minimal genetic penetrance (e.g., they are not influenced by the individual's genetic make-up) and so are dramatically different for every individual and indeed for every eye. If the variability inherent in the iris is expressed in statistical terms as the number of independent degrees of freedom, or forms of variability across individuals, the estimated number of such degrees of freedom is 266. This high information content, extracted by sophisticated computer image processing algorithms, enables an extremely accurate and sensitive personal identification technology. One recent study yielded an estimated crossover error rate of 1 in 1.2 million. This value represents the odds of a False Accept (incorrectly identifying a user as someone else) or a False Reject (failing to recognize a valid user), assuming that the system parameters are adjusted so that either type of error is equally likely.

Referring back to FIG. 13, the steps which comprise an exemplary anonymous iris identification process are illustrated. The data collection step includes acquisition of a high-quality iris image using a suitable imaging platform, at step 205. Typically this platform will utilize low-level infrared illumination and an infrared-sensitive camera. The resulting image is processed to extract a digital code, such as for example, a fixed-length 512-byte digital code, at step 210, that fully captures the unique information used for identification. If the data collection occurs as part of the enrollment process to be authorized for certain privileges, the IrisCode® record is stored, at step 215, in a database. The identity of the enrollee is also verified during enrollment, at step 220, and then the personal identification documents or credentials are returned or destroyed, but in either case, this personal identification information is not stored with the biometric.

If the biometric image is being collected and processed as part of the anonymous authentication process, however, the IrisCode® record is compared, at step 225 and step 230, against all records contained within the database, and the matching record, if one exists, is found. If a match is found at step 230, then the system reports an approved transaction or positive authentication of the identity at step 235. If no match is found, then the system reports a rejected transaction or negative authentication, at step 240, at which time the individual seeking to exercise a certain privilege may re-enter a new iris image, or terminate the process.

An exemplary imager that can be used with the present invention is a compact, handheld imaging apparatus manufactured by Iridian Technologies, Inc. of Marlton, N.J. The imager preferably has sensors and indicators which assist the human operator in aligning and focusing the device. The imager also automatically captures the image when proper positioning is achieved. Because it is small and compact, it is practical for use as an accessory to a personal computer, and for many business and consumer applications where cost is critical.

Referring back to FIG. 10, illustrated is a preferred embodiment of the handheld imager 950 that can be used with the present invention. Any known technique or apparatus for capturing the iris image can be used, such as those described in patent application Ser. No. 09/200,214, (Attorney Docket No. ICAN-0064), entitled “Handheld Iris Imaging Apparatus and Method”, filed on Nov. 25, 1998, which is herein incorporate by reference. The exemplary handheld, non-invasive, non-contacting iris imager comprises iris acquisition device 955, an imaging lens 960, a mirror 965, an optional diopter correction lens 970, and an illuminator 975. The imager 950 can be powered by a standard DC or AC supply, and preferably a battery (not shown).

The imager 950 acquires images of an iris with sufficient clarity, focus, and size for use with conventional image processing and comparison routines. A preferred image processing and comparison routine is described in U.S. Pat. No. 5,291,560, “Biometric Personal Identification System Based on Iris Analysis”, issued to Daugman, which is incorporated herein by reference. However, any processing and comparison technique can be used with the image that is acquired at the imager, such as the image pixel correlation technique described in U.S. Pat. No. 5,572,596, “Automated, Non-Invasive Iris Recognition System and Method”, issued to Wildes et al. and the techniques described in U.S. Pat. No. 4,641,349, “Iris Recognition System”, issued to Flom et al., both of which are incorporated herein by reference.

The system and method of anonymous biometric authentication of an individual using biometric for granting certain privileges of the present invention, has significant value in those situations where there are compelling needs for the accurate and reliable authentication of the identity of an individual as well as privacy concerns regarding the personal information relating to an individual's identity. The present invention also has value in that it can provide the anonymous authentication by iris recognition. Many types of privileges are assigned to individuals and it is necessary to authenticate that the individual seeking to use those privileges is in fact the person that they claim to be.

The anonymous biometric authentication system of the present invention provides more control over personal identification information and more control over the biometric to the individual. This is accomplished by not storing the personal identification information with the biometric in the good database and also, because only the individual can submit the biometric (e.g., a biometric is only submitted if the individual voluntarily submits one in order to gain access to a desired privilege) and also, the individual is the only one that can fix the biometric by, for example, submitting another biometric.

Although illustrated and described herein with reference to certain specific embodiments, it will be understood by those skilled in the art that the invention is not limited to the embodiments specifically disclosed herein. Those skilled in the art also will appreciate that many other variations of the specific embodiments described herein are intended to be within the scope of the invention as defined by the following claims.

What is claimed is:

1. A system for anonymous biometric authentication comprising:
a biometric acquisition device;
a second biometric of an individual seeking to exercise a privilege, said second biometric image captured by said biometric acquisition device;
a database comprising a plurality of first biometrics relating to said privilege; and
a processor coupled to said biometric acquisition device for receiving said second biometric and coupled to said database for accessing said stored first biometrics, said processor having a comparator for comparing said second biometric to said first biometrics stored in said database, wherein an anonymous biometric authentication of an identity of said individual is based on said comparison of said second captured biometric to said first stored biometric.

2. The system according to claim 1, wherein said privilege is granted based on the result of said anonymous biometric authentication of an identity of said individual.

3. The system according to claim 1, wherein said database further comprises a good database comprising a plurality of first biometrics authorized to exercise said privilege, wherein said processor accesses said stored first biometrics in said good database and said comparator compares said second biometric to said first biometrics stored in said good database, wherein said anonymous biometric authentication of an identity of said individual is based on a positive comparison of said second captured biometric image to one of said first stored biometric images in said good database.

4. The system according to claim 3, wherein said privilege is granted to said individual based on a positive anonymous biometric authentication of said identity of said individual indicated by a match of said second biometric to one of said first biometrics stored in said good database.

5. The system according to claim 1, wherein said database further comprises a bad database comprising a plurality of first biometrics not authorized to exercise said privilege, wherein said processor accesses said stored first biometrics in said bad database and said comparator compares said second biometric to said first biometrics stored in said bad database, wherein said anonymous biometric authentication of an identity of said individual is based on a positive comparison of said second captured biometric image to one of said first stored biometric images in said bad database.

6. The system according to claim 5, wherein said privilege is granted to said individual based on a negative anonymous biometric authentication of said identity of said individual indicated by no match of said second biometric to any of said first biometrics stored in said bad database.

7. The system according to claim 1, further comprising a transaction request that is received by said processor along with said second biometric, wherein said second captured biometric is compared by said processor said first biometrics stored in said database corresponding to said transaction request in order to grant said privilege corresponding to said transaction request.

8. The system according to claim 1, further comprising a transaction number that is received by said processor along with said second biometric, said transaction number being indicative of a specific transaction of said privilege which is exercised by said individual.

9. The system according to claim 1, wherein said second captured biometric is compared by said processor to all of said first biometrics stored in said database in order to verify said identity of said individual.

10. The s system according to claim 1, wherein said biometric is an iris of an eye.

11. The system according to claim 1, wherein said biometric acquisition device is an iris acquisition device for capturing an image of an iris of an eye of said individual.

12. The system according to claim 1, further comprising a second biometric record, said second biometric record comprising a biometric template extracted from said captured second biometric, a transaction request for said privilege sought to be exercised, and a transaction number, wherein said biometric template portion of said second biometric record binds an identity of said individual to said transaction request and said transaction number.

13. The system according to claim 1, further comprising a first biometric record, said first biometric record comprising a biometric template extracted from said first biometric and said privilege sought to be exercised, wherein said biometric template portion of said first biometric record binds an identity of said individual to said privilege assigned to said individual.

14. The system according to claim 1, wherein said privilege comprises one of a single privilege and a set of privileges.

15. The system according to claim 1, wherein said privilege comprises one or more of: access to a building, access to a secure area, cashing a personal check, using a credit card, performing a financial transaction, and fulfilling a reservation.

16. The system according to claim 1, further comprising an involuntary revocation system for involuntarily revoking said privilege, said involuntary revocation system comprising a temporary database for storing said second biometric and one or more of a transaction request and a transaction number, a verification authority for verifying whether said individual is authorized to exercise said privilege, a rejection code generated by said verification authority if said individual is not authorized to exercise said privilege, and a processor coupled to said verification authority for receiving said rejection code and coupled to said temporary database for retrieving said corresponding second biometric and one or more of said transaction request and said transaction number and coupled to a good database for comparing said second biometric to said first biometrics stored in said good database, wherein one of said first biometrics matching said second biometric is removed from said good database based on said comparison.

17. The system according to claim 16, further comprising an involuntary revocation record, said involuntary revocation record comprising said second biometric and said rejection code documenting reasons for said involuntary revocation and said involuntary revocation record being stored in a database.

18. The system according to claim 1, further comprising a voluntary revocation system for voluntarily revoking said privilege, said voluntary revocation system comprising a biometric acquisition device, a transaction request to voluntarily revoke said privilege, a second biometric that is voluntarily submitted by an individual seeking to voluntarily revoke said privilege, a processor for accessing said database containing said plurality of first biometrics, and a comparator for comparing said second voluntarily submitted biometric to all of said first biometrics until a match is found, wherein said matching first biometric is removed from said database.

19. The system according to claim 1, wherein said first biometrics and said second biometrics are encrypted to further protect an identity of said individual.

20. The system according to claim 19, wherein said encryption is accomplished using one of public-key and private-key techniques.

21. The system according to claim 1, further comprising a biometric enrollment system comprising:
a biometric acquisition device;
a first biometric of an individual seeking to be enrolled, said first biometric captured by said biometric acquisition device;
one or more credentials indicative of an identity of said individual;
an enrollment authority for verifying an identity of said individual seeking enrollment using said one or more credentials; and
a good database for storing said captured first biometric image, wherein said good database stores a plurality of first biometrics of individuals enrolled in said anonymous biometric authentication system and wherein said credentials are not stored in said good database with said first biometric.

22. A system for anonymous biometric authentication comprising:
a biometric enrollment system comprising:
a biometric acquisition device;
a first biometric of an individual seeking to be enrolled, said first biometric captured by said biometric acquisition device;
one or more credentials indicative of an identity of said individual;
an enrollment authority for verifying an identity of said individual seeking enrollment using said one or more identification documents;
a good database for storing said captured first biometric after said identity of said individual seeking enrollment has been verified, wherein said good database stores a plurality of first biometrics of individuals enrolled in said anonymous biometric authentication system and wherein said credentials are not stored in said good database with said first biometric;
a biometric authentication system comprising:
a biometric acquisition device;
a second biometric of an individual seeking to exercise a privilege, said second biometric captured by said biometric acquisition device; and
a processor coupled to said biometric acquisition device for receiving said second biometric and coupled to said good database for accessing said stored first biometrics, said processor comparing said second biometric to said first biometrics stored in said database;
wherein an anonymous authentication of said individual is based on said comparison of said second captured biometric to said first stored biometrics and wherein said privilege is granted based on the result of said anonymous biometric authentication of an identity of said individual.

23. A system for anonymous biometric authentication of an individual for granting of one or more privileges comprising:
a first biometric indicative of an identity of an individual;
one or more credentials indicative of said identity of said individual;
a privilege sought to be exercised by said individual;
a first memory for storing said first biometric of said individual once said identity of said individual has been verified using said credentials, said first memory comprising a plurality of first biometrics for all individuals authorized to exercise said privilege;
a second memory for storing a second biometric obtained by a biometric acquisition device from an individual seeking to exercise said privilege; and
a comparator for comparing said second biometric of said second memory with said plurality of first biometrics of said first memory for anonymous biometric authentication of said individuals authorized to exercise said privilege.

24. The system according to claim 23, further comprising an authentication code generated by said anonymous biometric authentication system granting said privilege based on a positive comparison of said second biometric of said second memory with said first stored biometric of said first memory, wherein said individual associated with said second biometric may exercise said privilege.

25. The system according to claim 23, wherein said biometric comprises an iris of an eye and said biometric acquisition device comprises a camera.

26. The system according to claim 23, wherein said comparator comprises a processor responsive to an output of said biometric acquisition device for comparing said biometric of said second memory with said all of said stored biometrics of said first memory.

27. The system according to claim 23, wherein
said first memory stores at least one template of at least one image of at least one iris of an eye of said individual indicative of said identity of said individual that has been assigned one or more privileges;
said second memory stores a template of an iris image obtained by an iris acquisition device from an iris of an eye of an individual seeking to exercise said one or more privileges; and
said comparator compares said template of said iris image of said second memory with said stored template of said first memory for anonymous biometric authentication of said individual, and wherein no personal identifying information is stored in either of said first memory and said second memory.

28. A method of anonymous biometric authentication of an individual for granting one or more privileges comprising the steps of:
submitting a transaction request indicative of a privilege that is sought to be exercised;
capturing a biometric of an individual;
storing said captured biometric in a memory;
comparing said captured biometric to a plurality of enrolled biometrics stored in a database corresponding to said privilege that is being sought to be exercised;
anonymously authenticating an identity of said individual based on said step of comparing said captured biometric to said stored biometrics in said database; and
granting said privilege based on said step of anonymously authenticating said individual.

29. The method according to claim 28, further comprising generating an authorization code based on said step of anonymously authenticating said individual.

30. The method according to claim 28, further comprising generating an approval authorization code if one of said stored biometrics matches said captured biometric.

31. The method according to claim 28, further comprising generating one of a rejection authorization code and no authorization code if one of said stored biometrics does not match said captured biometric.

32. The method according to claim 28, further comprising the step of involuntarily revoking said privileges, wherein said step of involuntarily revoking said privileges further comprises the steps of:
saving said transaction request and said second biometric in a temporary transaction database;
transmitting said transaction request and said second biometric to a verification authority;
verifying said individual submitting said second biometric has been assigned said privilege sought to be exercised;
transmitting an authorization code to said temporary transaction database and finding said transaction request and said second biometric in said temporary transaction database;
searching said good database to find a matching biometric corresponding to said second biometric; and
removing said corresponding first biometric from said good biometric database based on said step of verifying.

33. The method according to claim 28, further comprising the step of voluntarily revoking said privileges, wherein said step of voluntarily revoking said privileges further comprises the steps of:
receiving a second biometric from an individual seeking to have a privilege voluntarily revoked;
searching said good database to find a matching first biometric; and
removing said first biometric based on said matching.

34. The method according to claim 28, wherein said step of capturing a biometric of an individual further comprises capturing an iris image of an eye as said biometric of said individual.
